(19) United States
(12) Patent Application Publication
(10) Pub. No.: US 2014/0282066 A1
(43) Pub. Date: Sep. 18, 2014

(54) DISTRIBUTED, INTERACTIVE, COLLABORATIVE, TOUCHSCREEN, COMPUTING SYSTEMS, MEDIA, AND METHODS

(71) Applicant: PROMONTORY FINANCIAL GROUP, LLC, Washington, DC (US)

(72) Inventors: Michael Andrew Dawson, Washington, DC (US); Justin Bing Liang, Fairfax, VA (US); Dustin Karl Palmer, Oakton, VA (US); Andrew Sing Huo Ting, Washington, DC (US)

(73) Assignee: PROMONTORY FINANCIAL GROUP, LLC, Washington, DC (US)

(21) Appl. No.: 13/800,395

(22) Filed: Mar. 13, 2013

(51) Int. Cl. H04L 29/06

(52) U.S. Cl. CPC H04L 65/403
USPC 715/748

(57) ABSTRACT

A software module and method to allow two or more mobile devices to connect so that their screens form a virtual touch table allowing collaboration across a larger surface than would be afforded on any individual mobile device. The virtual touch table is optionally enhanced by, among other things, allowing each user to interact in collaborative environments with other users and to easily import and export information between mobile devices forming the virtual touch table.

### BACKGROUND OF THE INVENTION

The present invention relates to the use of multiple portable computing devices initially within a certain proximity to transfer digital items, including data, documents, and/or images, using gestures, as if to simulate a large, multi-user touch table surface.

### SUMMARY OF THE INVENTION

Although touch tables are gaining popularity as devices to facilitate creative collaboration, they have severe limitations including: size, weight, immobility, expense, and lack of cleanliness. Individuals wishing to use a touch table must go to a dedicated touch table facility. They are also required to share a common surface, which can become dirty. Further, the number of users is limited by the number that can physically fit around the touch table, whereas the size of the touch table is limited by the width across which an individual can comfortably reach. Rather than leverage hardware already purchased by a company or individuals, existing touch table technology requires that the company or individual buy a new dedicated piece of equipment, thereby adding expense. In addition, users must find a way to get information to and from the touch table, adding unnecessary steps and, thereby, discouraging use.

It is increasingly common for a person to own a portable computing device, such as a smart phone or electronic tablet, with touchscreen functionality. Most people who own such devices use them for a variety of communicative purposes, including voice calls, email, and file transfers, and, increasingly, for enhancing productivity through the use of task management apps. Such apps usually require the use of an online network to transfer data between devices (e.g., the “cloud”) or a physical connection between two devices.

The platforms, systems, media, and methods provided herein allow multiple users to exchange digital information using only gestures on their touchscreen mobile devices over a networked interface, as if passing documents or orders around a table. A user is able to transfer data from their “source” device to one or more “destination” devices using wireless communications technologies and a series of hand gestures. No particular operation or physical connection is required to obtain the file at the destination devices. A responsive and unitary software module, installed on each mobile device, gives users the ability to detect proximate devices and, once connected, share on-screen visualizations and interactions seamlessly in a common work space, fostering collaboration and increased productivity. Accordingly, the platforms, systems, media, and methods provided herein successfully emulate the idea of a touch-based interactive conference table, which allows users to create, manipulate, and transfer data instantly to others in geospatial proximity, while overcoming the shortfalls of existing systems.

The platforms, systems, media, and methods provided herein create a shared, collaborative virtual work environment by exploiting wireless communications technologies that allow for real-time distribution of digital information across local and remote spaces.

In one aspect, disclosed herein are computer-implemented systems comprising: a plurality of mobile processing devices, each device comprising an operating system configured to perform executable instructions, a touchscreen, and a memory; and a mobile application, provided to each mobile processing device, the application comprising: a software module for measuring proximity of each of the devices; a software module for creating a distributed, interactive collaboration Graphical User Interface (GUI), the GUI presenting a portion of a single, contiguous environment, the portion of the environment determined by the proximity and the relative positions of each of the devices; a software module for creating or identifying a data object in response to a first touchscreen gesture; and a software module for transferring the data object in response to a second touchscreen gesture, the second gesture indicating at least one destination for the data object. In some embodiments, the plurality of mobile processing devices includes about 2 to about 20 devices. In some embodiments, the software's GUI comprises a representation of a user. In some embodiments, the GUI emulates the environment of a boardroom, a conference room, or a classroom. In some embodiments, the data object comprises: an image file, a video file, an audio file, a document, a text file, a word processor file, a spreadsheet, a presentation file, a calendar event, a task, an interactive element, an executable file, a combination thereof, or a database thereof. In some embodiments, the application further comprises a software module for managing permissions for transferring data objects. In some embodiments, the application further comprises a software module for creating a record of data objects transferred, the record comprising source, destination, and content.

In another aspect, disclosed herein are non-transitory computer readable storage media encoded with a mobile application including executable instructions that when provided to each of a plurality of touchscreen mobile devices create a distributed, interactive collaboration GUI, the application comprising: a software module for measuring proximity of each mobile device of a plurality of mobile devices provided the mobile application; a software module for displaying a distributed, interactive collaboration GUI, the interface presenting a portion of a single, contiguous environment, the portion of the environment determined by the proximity and the relative positions of each of the mobile devices; a software module for creating or identifying a data object in response to a first touchscreen gesture; and a software module for transferring the data object in response to a second touchscreen gesture, the second gesture indicating at least one destination for the data object. In some embodiments, the plurality of mobile devices includes about 2 to about 20 devices. In some embodiments, the GUI comprises a representation of a user. In some embodiments, the GUI emulates the environment of a boardroom, a conference room, or a classroom. In some embodiments, the data object comprises: an image file, a video file, an audio file, a document, a text file, a word processor file, a spreadsheet, a presentation file, a calendar event, a task, an interactive element, an executable file, a combination thereof, or a database thereof. In some embodiments, the application further comprises a software module for managing permissions for transferring data objects. In some embodiments, the application further comprises a software module for creating a record of data objects transferred, the record comprising source, destination, and content. In some embodiments, the application further comprises a software module for maintaining the configuration of the environment and data object transfer functionality when the devices are removed from proximity.

In another aspect, disclosed herein are computer-implemented methods of providing an interactive collaboration environment, the environment distributed across a plurality of touchscreen mobile devices, the method comprising the steps of: measuring, by each of the mobile devices, the proximity of each of the other mobile devices of the plurality of mobile devices; displaying, by each of the mobile devices, a distributed, interactive GUI, the interface presenting a portion of a single, contiguous environment, the portion of the environment determined by the proximity and the relative positions of each of the mobile devices; creating or identifying a data object in response to a first touchscreen gesture; and transferring the data object in response to a second touchscreen gesture, the second gesture indicating at least one destination for the data object.

In another aspect, disclosed herein are computer-implemented systems comprising: a plurality of mobile processing devices, each device comprising an operating system configured to perform executable instructions, a touchscreen, and a memory; and a mobile application, provided to each mobile processing device, the application comprising: a software module for measuring proximity of each of the devices; a software module for creating a distributed, interactive GUI, the GUI presenting a representation of an environment, the environment including representations of a plurality of users, the representations of the users displayed in the environment based on proximity and relative positions of each of the devices; a software module for creating or identifying a data object in response to a first touchscreen gesture; and a software module for transferring the data object in response to a second touchscreen gesture, the second gesture indicating at least one destination for the data object. In some embodiments, the plurality of mobile processing devices includes about 2 to about 20 devices. In some embodiments, the GUI emulates the environment of a boardroom, a conference room, or a classroom. In some embodiments, the data object comprises: an image file, a video file, an audio file, a document, a text file, a word processor file, a spreadsheet, a presentation file, a calendar event, a task, an interactive element, an executable file, a combination thereof, or a database thereof. In some embodiments, the application further comprises a software module for managing permissions for transferring data objects. In some embodiments, the application further comprises a software module for transferring the representation of the environment displayed on a device to one or more other devices. In some embodiments, the application further comprises a software module for creating a record of data objects transferred, the record comprising source, destination, and content.

In another aspect, disclosed herein are non-transitory computer readable storage media encoded with a mobile application including executable instructions that when provided to each of a plurality of touchscreen mobile devices create a distributed, interactive GUI, the application comprising: a software module for measuring proximity of each mobile device of a plurality of mobile devices provided the mobile application; a software module for creating a distributed, interactive GUI, the GUI presenting a representation of an environment, the environment including representations of a plurality of users, the representations of the users displayed in the environment based on proximity and relative positions of each of the devices; a software module for creating or identifying a data object in response to a first touchscreen gesture; and a software module for transferring the data object in response to a second touchscreen gesture, the second gesture indicating at least one destination for the data object. In some embodiments, the plurality of mobile devices includes about 2 to about 20 devices. In some embodiments, the GUI emulates the environment of a boardroom, a conference room, or a classroom. In some embodiments, the data object comprises: an image file, a video file, an audio file, a document, a text file, a word processor file, a spreadsheet, a presentation file, a calendar event, a task, an interactive element, an executable file, a combination thereof, or a database thereof. In some embodiments, the application further comprises a software module for managing permissions for transferring data objects. In some embodiments, the application further comprises a software module for transferring the representation of the environment displayed on a device to one or more other devices. In some embodiments, the application further comprises a software module for creating a record of data objects transferred, the record comprising source, destination, and content. In some embodiments, the application further comprises a software module for maintaining the configuration of the environment and data object transfer functionality when the devices are removed from proximity.

In another aspect, disclosed herein are computer-implemented methods of providing an interactive collaboration environment, the environment distributed across a plurality of touchscreen mobile devices, the method comprising the steps of: measuring, by each of the mobile devices, the proximity of each of the other mobile devices of the plurality of mobile devices; displaying, by each of the mobile devices, a distributed, interactive GUI, the GUI presenting a representation of an environment, the environment including representations of a plurality of users, the representations of the users displayed in the environment based on proximity and relative positions of each of the devices; creating or identifying a data object in response to a first touchscreen gesture; and transferring the data object in response to a second touchscreen gesture, the second gesture indicating at least one destination for the data object.

### BRIEF DESCRIPTION OF THE DRAWINGS

FIG. 1 shows a non-limiting example of an application for a distributed touch table.

FIG. 2 shows a non-limiting example of functionality for a distributed touch table.

FIG. 3 shows a non-limiting example of data transfer using NFC technology.

FIG. 4 shows a non-limiting example of data transfer for a virtual boardroom.

FIG. 5 shows a non-limiting example of a software application for a virtual boardroom.

FIG. 6 shows a non-limiting example of GUI transfer functionality in a virtual boardroom environment.

FIG. 7 shows a non-limiting example of a GUI on a source device showing the locations of destination devices on the border of the source device display.

FIG. 8 shows a non-limiting example of a possibility for an alternative flicking gesture allowing two data objects on a source device to be transferred to two destination devices.

FIG. 9 shows a non-limiting example of a far-field mode for a distributed touch table application, wherein a collaborative environment is established and configured when a plurality of mobile devices are in proximity and the environment is maintained via wide area network or the internet when the devices are separated.

FIG. 10 shows non-limiting examples of the hand gestures used on the touchscreen device to create, retrieve, manipulate, or transfer data.

FIG. 11 shows an exemplary process flow for use of a distributed touch table described herein.

### DETAILED DESCRIPTION OF THE INVENTION

Current touch tables suffer from severe disadvantages including: large size, high weight, substantial immobility, high cost, significant lack of cleanliness, and limitations on the number of concurrent users. Moreover, individuals wishing to use a current touch table must go to a dedicated touch table facility, which introduces unacceptable time delays, inconvenience, and additional expense.

The platforms, systems, media, and methods provided herein successfully emulate the idea of a traditional touch-based interactive conference table, but overcome the problems of existing systems. Advantages of the platforms, systems, media, and methods provided herein include allowing multiple users to exchange digital information using only gestures on their mobile devices over a networked interface, as if passing documents or orders around a table. No particular operation or physical connection is required to transfer a file from a source device to one or more destination devices. Further advantages include a responsive and unitary software module, installed on each mobile device, that gives users the ability to share on-screen visualizations and interactions seamlessly in a common work space, fostering collaboration and increased productivity.

Described herein, in certain embodiments, are computer-implemented systems comprising: a plurality of mobile processing devices, each device comprising an operating system configured to perform executable instructions, a touchscreen, and a memory; and a mobile application, provided to each mobile processing device, the application comprising: a software module for measuring proximity of each of the devices; a software module for creating a distributed, interactive collaboration GUI, the GUI presenting a portion of a single, contiguous environment, the portion of the environment determined by the proximity and the relative positions of each of the devices; a software module for creating or identifying a data object in response to a first touchscreen gesture; and a software module for transferring the data object in response to a second touchscreen gesture, the second gesture indicating at least one destination for the data object.

Also described herein, in certain embodiments, are non-transitory computer readable storage media encoded with a mobile application including executable instructions that when provided to each of a plurality of touchscreen mobile devices create a distributed, interactive collaboration GUI, the application comprising: a software module for measuring proximity of each mobile device of the plurality of mobile devices provided the mobile application; a software module for displaying a distributed, interactive collaboration GUI, the GUI presenting a portion of a single, contiguous environment, the portion of the environment determined by the proximity and the relative positions of each of the mobile devices; a software module for creating or identifying a data object in response to a first touchscreen gesture; and a software module for transferring the data object in response to a second touchscreen gesture, the second gesture indicating at least one destination for the data object.

Also described herein, in certain embodiments, are computer-implemented methods of providing an interactive collaboration GUI, the GUI distributed across a plurality of touchscreen mobile devices, the method comprising the steps of: measuring, by each of the mobile devices, the proximity of each of the other mobile devices of the plurality of mobile devices; displaying, by each of the mobile devices, a distributed, interactive collaboration GUI, the GUI presenting a portion of a single, contiguous environment, the portion of the environment determined by the proximity and the relative positions of each of the mobile devices; creating or identifying a data object in response to a first touchscreen gesture; and transferring the data object in response to a second touchscreen gesture, the second gesture indicating at least one destination for the data object.

Also described herein, in certain embodiments, are computer-implemented systems comprising: a plurality of mobile processing devices, each device comprising an operating system configured to perform executable instructions, a touchscreen, and a memory; and a mobile application, provided to each mobile processing device, the application comprising: a software module for measuring proximity of each of the devices; a software module for creating a distributed, interactive collaboration GUI, the GUI presenting a representation of an environment, the environment including representations of a plurality of users, the representations of the users displayed in the environment based on proximity and relative positions of each of the devices; a software module for creating or identifying a data object in response to a first touchscreen gesture; and a software module for transferring the data object in response to a second touchscreen gesture, the second gesture indicating at least one destination for the data object.

Also described herein, in certain embodiments, are non-transitory computer readable storage media encoded with a mobile application including executable instructions that when provided to each of a plurality of touchscreen mobile devices create a distributed, interactive collaboration GUI, the application comprising: a software module for measuring proximity of each mobile device of a plurality of mobile devices provided the mobile application; a software module for creating a distributed, interactive collaboration GUI, the GUI presenting a representation of an environment, the environment including representations of a plurality of users, the representations of the users displayed in the environment based on proximity and relative positions of each of the devices; a software module for creating or identifying a data object in response to a first touchscreen gesture; and a software module for transferring the data object in response to a second touchscreen gesture, the second gesture indicating at least one destination for the data object.

Also described herein, in certain embodiments, are computer-implemented methods of providing an interactive collaboration GUI, the GUI distributed across a plurality of touchscreen mobile devices, the method comprising the steps of: measuring, by each of the mobile devices, the proximity of each of the other mobile devices of a plurality of mobile devices; displaying, by each of the mobile devices, a distributed, interactive collaboration GUI, the GUI presenting a representation of an environment, the environment including representations of a plurality of users, the representations of the users displayed in the environment based on proximity and relative positions of each of the devices; creating or identifying a data object in response to a first touchscreen gesture; and transferring the data object in response to a second touchscreen gesture, the second gesture indicating at least one destination for the data object.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Distributed Touch Table

In some embodiments, the platforms, systems, media, and methods described herein include a distributed touch table, or use of the same. In further embodiments, the platforms, systems, media, and methods described herein include one or more of: a software module for measuring proximity each of a plurality of mobile processing devices; a software module for measuring the relative positions of each of a plurality of mobile processing devices; a software module for creating a GUI presenting an environment based on the proximity and the relative positions of each of the devices; and a software module for transferring a data object between mobile devices.

Many wireless communications protocols and standards are suitable for detection of devices, determination of proximity and relative position of the devices, and transfer of data between devices. In various embodiments, the wireless communications utilize radio waves, visible light, or interpretation of captured images. In some embodiments, communications suitably utilize Near Field Communication (NFC) protocols and standards. In some embodiments, communications suitably utilize BlueTooth and/or Bluetooth Low Energy protocols and standards. In some embodiments, communications suitably utilize ZigBee protocols and standards. In some embodiments, communications suitably utilize Visible Light Communication (VLC), including Li-Fi, protocols and standards. In some embodiments, communications suitably utilize Wi-Fi and/or WiMAX protocols and standards.

In some embodiments, determination of proximity and relative position of each of a plurality of mobile devices utilizes GPS technology integrated with a mobile device and accessed by an application. In some embodiments, determination of proximity and relative position suitably utilizes a still or video camera associated with a device to capture images which are used in conjunction with one or more communications protocols and/or GPS to supplement position determinations. In further embodiments, captured images are subsequently subjected to one or more computer-based image interpretation algorithms (e.g., facial recognition, etc.) to enhance a virtual environment by improving accuracy or adding metadata to elements of the environment.

In light of the disclosure provided herein, those of skill in the art will recognize that suitable operating ranges for the wireless communications are dependent, at least in part, on the type of wireless communication employed. In various near-field embodiments, suitable ranges include, by way of non-limiting examples, about 1, 10, 20, 30, 40, 50, 60, 70, 80, 90, 100, or more centimeters, including increments therein. In further near-field embodiments, suitable ranges include, by way of non-limiting examples, about 1, 10, 20, 30, 40, 50, 60, 70, 80, 90, 100, or more meters, including increments therein.

In some embodiments, the platforms, systems, media, and methods described herein include a plurality of mobile processing devices, each provided with a mobile application. Many configurations, described further herein, are suitable for the application GUI.

In some embodiments, the application includes a software module for creating a distributed, interactive collaboration GUI, the GUI presenting a portion of a single, contiguous environment, the portion of the environment determined by the proximity and the relative positions of each of the devices. By way of example, in certain embodiments, each of a plurality of mobile devices display a distributed touch table GUI, wherein the devices are proximity and operating together to present a portion of a single, contiguous environment, the portion of the environment determined by the proximity and the relative positions of each of the mobile devices. In further embodiments, such a single, contiguous environment is adapted for use by a single user. In other embodiments, such a single, contiguous environment is adapted for use by a plurality of users.

In other embodiments, the application includes a software module for creating a distributed, interactive collaboration GUI, the GUI presenting a representation of an environment, the environment including representations of a plurality of users, the representations of the users displayed in the environment based on proximity and relative positions of each of the devices. By way of further example, in certain embodiments, each of a plurality of mobile devices display a distributed touch table GUI that presents a representation of a virtual environment. In further embodiments, the environment is configured to align with the point of view of each user based on proximity and relative positions of each of the devices. In still further embodiments, the environment includes a representation of each user, the representation displayed in the environment based on proximity and relative position. In further embodiments, such a representation of an environment maintains the representations of the users displayed in the environment even after the devices are separated and no longer in proximity.

Aspects of the GUIs are suitably updated at various intervals. For example, the number of devices in proximity, the degree of proximity and relative position of the devices, and the number and identity of users is suitably monitored for the purpose of updating the configuration of the representations in the GUIs. In some embodiments, the GUIs are updated substantially in real-time.

The plurality of devices suitably includes a wide ranging number of devices. In various embodiments, suitable numbers of devices include, by way of non-limiting examples, about 2, 3, 4, 5, 6, 7, 8, 9, 10, 11, 12, 13, 14, 15, 16, 17, 18, 19, 20, or more devices, including increments therein. In various embodiments, suitable numbers of devices include, by way of non-limiting examples, about 10, 20, 30, 40, 50, 60, 70, 80, 90, 100, or more devices, including increments therein. In various embodiments, suitable numbers of devices include, by way of non-limiting examples, about 100, 200, 300, 400, 500, 600, 700, 800, 900, 1000, or more devices, including increments therein.

Referring to FIG. 1, in a particular embodiment, the touchscreen devices, when placed in immediate adjacency, detect the presence of the other devices using NFC technologies and connect using the software module to share data. Together, the devices form a single visual interface across which information—including, but not limited to, tasks, documents, and media (100, 105)—are optionally passed. In an embodiment, users interact, create, manipulate, and transfer packets of information collaboratively, using only hand gestures on their touchscreen devices. This distributed touch table configuration 110 allows each connected participant to provide input both independently and collaboratively into the integrated environment.

Referring to FIG. 2, in a particular embodiment, the touchscreen devices, when placed in geospatial proximity, such as around a table—but not necessarily in immediate adjacency—emulate a virtual boardroom. In this configuration, the devices also detect the presence of other devices using NFC technologies, enabling the creation, manipulation, and transfer of information, as in FIG. 1. In an embodiment, a source user creates a packet of information on the source device 200 using hand gestures and flicks it to a destination device 205, which receives the information without any additional operations being performed.

Referring to FIG. 3, in a particular embodiment, the accompanying software module not only allows a source user to transfer a packet of information 300 to other devices but also informs the source user in real-time when that information has been altered or manipulated by the destination device. In an embodiment, the devices, when connected using NFC technologies 305, “speak to” each other without any operations being performed. This configuration allows for a “principal-agent” relationship in which the source user (also referred to as a principal) optionally gives tasks or directives to a destination user (also referred to as an agent), whose altered information 310—for example, a completed task—is automatically reverted back to the source user without any additional operations being performed. In this embodiment, the principal's source device, using NFC technologies 305, automatically detects what work has been completed by the agent(s) simply by being in close proximity to the agents' devices.

Referring to FIG. 4, in a particular embodiment, the accompanying software module provides a variety of GUIs that create a visual representation of the users based on proximity and the relative positions of each of the devices. In an embodiment, this particular GUI 400 displays a virtual boardroom after the source device has connected to, and detected the relative locations of, the destination devices using NFC or camera technologies.

Referring to FIG. 5, in a particular embodiment, the virtual boardroom serves as an environment for information transfer using only hand gestures. In this embodiment, the source user, having already detected the destination devices in proximity using NFC or camera technologies, creates a packet of information that is flicked to a destination device displayed on the GUI. The new information 500 is received by the destination device without any additional operations being performed.

Referring to FIG. 6, in a particular embodiment, the selected GUI 600 appearing on one user's device is optionally transferred to another user's device using NFC technologies. In this configuration, the software module allows users to “see” what other users are seeing on their respective devices.

Referring to FIG. 7, in a particular embodiment, a GUI 700 displays borders that represent the destination devices to which the source device has connected using NFC, camera, or GPS technologies. Flicking a packet of created or retrieved information to the area of the border corresponding to the destination device results in the transmission of the information to that destination device without any additional operations being performed. The source device will retain information on the sent data even as it is manipulated or changed by the recipient, who optionally pushes the file back to the source device or passes it along to other devices.

Referring to FIG. 8, in a particular embodiment, the software module allows for the transfer of information to more than one destination device using only hand gestures. In this embodiment, the source user creates and flicks a packet of information to two destination devices, who both receive the same information.

Referring to FIG. 9, in a particular embodiment, a distributed touch table application includes a far-field mode 905. In further embodiments, a far-field mode allows maintenance of a collaborative environment, configured based on the relative positions of a plurality of mobile devices in proximity and communicating via near-field technology 900, even after the devices are separated (e.g., no longer in proximity). In various embodiments, a far-field mode maintains communication among the devices via wide area network, the internet, or cloud computing 910.

FIG. 11 illustrates a particular non-limiting process flow for use of a distributed touch table. In this embodiment, a source device first detects the presence of other proximate devices using, for example, NFC technologies. If no other devices executing the application are present within a suitable range, the device returns to a detection mode. If one or more other devices executing the application are present within range, the source device may connect to each of the other proximate devices. Further, in this embodiment, each user selects a GUI environment to display (e.g., a classroom, a boardroom, etc.). A source user can then create or retrieve one or more packets of information (e.g., data packets) by a first touchscreen gesture (e.g., a touch and hold gesture, etc.). The source user then sends the one or more data packets to one or more proximate destination devices using a second touchscreen gesture (e.g., a flick gesture, etc.). In this embodiment, the one or more destination devices then receive the one or more packets of data from the source device. In some cases, one or more of the destination devices alter the data. In this embodiment, if the data is altered, the source device automatically acknowledges the changes, which are displayed on the source user's GUI.

### Data Object

In some embodiments, the platforms, systems, media, and methods described herein include one or more data objects, or use of the same. Many types of data are suitable. In further embodiments, the data transferred using the distributed touch table includes, but is not limited to, information containing tasks and/or directives. In further embodiments, the data transferred using the distributed touch table includes, but is not limited to, text files, contact information, word processing documents, presentations, spreadsheets, databases, and combinations thereof. In further embodiments, the data transferred using the distributed touch table includes, but is not limited to, multimedia files, interactive files, audio files, illustrations, photographs, videos, and combinations thereof. In further embodiments, the data transferred using the distributed touch table includes, but is not limited to, applications and/or executable files.

### Gestures

In some embodiments, the platforms, systems, media, and methods described herein include one or more gestures, or use of the same. In further embodiments, suitable gestures are performed by a user on a touchscreen of a mobile device described herein.

Referring to FIG. 10, various hand gestures are optionally used to create, manipulate, and distribute information using the software module. Holding a finger on the touchscreen 1000, for example, creates or retrieves a packet of information. A double finger tap 1005, for example, on a packet of information reveals additional data embedded within the object. A flicking or pushing motion done with the fingers 1010, for example, sends the information to one or more devices. A push and grow motion with two fingers 1015 (e.g., reverse pinch), for example, expands a packet of information, or, as demonstrated in FIG. 8, sends a packet of information to multiple devices. A push and shrink motion with two fingers 1020 (e.g., pinch), for example, reduces the size of the packet.

### Data Transfer

In some embodiments, the platforms, systems, media, and methods described herein include data transfer, or use of the same. In one embodiment, after creating a “packet” of information, such as a task or directive, on the source device, the individual transmits the information by flicking the information in the direction of one or more destination devices (or a representation of a destination in a GUI), where it will be received instantly without any additional operations being performed. See FIGS. 2 and 8. In further embodiments, the source device will retain information on the sent data even as it is optionally manipulated or changed by the recipient, who optionally pushes the file back to the source device or passes it along to other devices.

In some embodiments, the directionality and type of gestures determine whether only one destination device receives the information or whether one or more destination devices receive the information.

In some embodiments, through NFC technologies or cameras on the source device, the source device detects the location of the destination devices relative to the source device to allow the direction of the flicking gesture to determine which destination device receives the information.

In some embodiments, the source device detects other destination devices through NFC technologies, GPS, or cameras on the source device and represents such destination devices through the GUI on the source device screen. After creating a “packet” of information, such as a task or directive, on the source device, the individual flicks the information to an area of the source device screen corresponding to one or more detected destination devices, resulting in the transmission of the information to one or more destination devices, where it will be received instantly without any additional operations being performed. The GUI for the source device screen displaying the destination devices could be a virtual boardroom as shown in FIGS. 4-6. Alternatively, the GUI displaying the destination devices could be a border on the source device screen broken into areas labeled with the name of each destination device as shown in FIG. 7. Flicking the information to the area of the border corresponding to the destination device would result in the transmission of the information to that destination device. The source device will retain information on the sent data even as it is manipulated or changed by the recipient, who optionally pushes the file back to the source device or passes it along to other devices.

In another embodiment, multiple source devices are physically placed next to each other as shown in FIG. 8. After creating a “packet” of information, such as a ball, on the source device, the individual optionally flicks the information to the border of the source device which is next to one or more destination devices, resulting in the transmission of the information to one or more destination devices, where it will be received instantly without any additional operations being performed.

### Uses

In some embodiments, the platforms, systems, media, and methods described herein are useful in a wide range of contexts. In some embodiments, the mobile interfaces described herein are used for the distribution and exchange of, for example, information, ideas, documents, tasks, and directives during or after group meetings. Individuals on a “source” device optionally create a task or list of tasks and distribute these orders to one or more “destination” devices nearby using simple gestures such as a directional flick of the finger aimed at another device. The invention thus mimics the “live” surface of an interactive touch table using only mobile devices.

In some embodiments, the mobile interfaces described herein allow users to see what data has been distributed to the group simply by coming in close contact with the other users. Once connected via, for example, BlueTooth, information that has been previously exchanged is optionally displayed on the source device to see how it has been altered or completed by the recipient. The invention thus permits users to hold one another accountable for these tasks by visualizing precisely how much work each user has been assigned.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In further embodiments, a keyboard is a physical keyboard. In other embodiments, a keyboard is a virtual keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program is optionally written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, location, proximity, and data transfer information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Group Meeting

A distributed touch table is used for the distribution and exchange of tasks and directives during group meetings. Individuals on a “source” device optionally create a task or list of tasks and distribute these orders to one or more “destination” devices nearby using simple gestures such as a directional flick of the finger aimed at another device. The role of a device as a “source” or a “destination” is fluid and changes based on the actions of the user, i.e., sending or receiving data.

### Example 2

### Collaborative Game

A distributed touch table is used to play collaborative games, where individuals playing a game connect mobile devices and create, manipulate, and transfer virtual balls or other objects between their mobile devices using each mobile device's touchscreen interface.

### Example 3

### Collaborative Design

A distributed touch table is used for collaborative design by a group of individuals. Each individual's device displays the same visual design, such as an architecture blueprint or a technical drawing. An individual creates objects to annotate or modifies the design on his or her source device. The individual then uses a simple gesture such as a directional flick of the finger (see e.g., FIG. 9, 910) to transfer this object to the other individuals' destination devices, instantly updating the design on the other individual's destination devices. The distributed touch table's ability to share and instantly update designs between multiple devices allows for more efficient collaborative design.

### Example 4

### Education

A distributed touch table is used to facilitate interaction in an educational or training environment, such as a classroom. For example, one or more instructors and one or more pupils use the invention to share notes, assignments, reading materials, etc. Pupils use the invention to submit questions to the instructors.

### Example 5

### Investigation

A distributed touch table is used to facilitate collaboration by investigators. One or more investigators use their mobile device to collect information related to the investigation, such as witness statements, documents, or photographs. They then connect their devices in the distributed touch table and share information. For example, photographs taken by one investigator are distributed to other investigators, based on their relevance to each of the investigator's lines of inquiry.

### Example 6

### Health Care

A distributed touch table is used for medical training, much like multi-touch tables are used for medical visualization to simulate clinical reality. When placed together, 24 mobile devices create a “mosaic” of life-sized body parts that are rendered and manipulated collaboratively and by each individual user. Unlike a static touch table, however, the objects, or parts thereof, are optionally passed to one another using a flicking gesture, allowing destination users to see the source user's images and actions and work with them remotely. For image-centric specialties, such as surgery, such a device is invaluable for training in a safe, secure, and collaborative virtual environment.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented system comprising:
a. a plurality of mobile processing devices, each device comprising an operating system configured to perform executable instructions, a touchscreen, and a memory; and
b. a mobile application, provided to each mobile processing device, the application comprising:
i. a software module for measuring proximity of each of the devices;
ii. a software module for creating a distributed, interactive collaboration GUI, wherein the GUI interacts with the other GUIs of the plurality of mobile processing devices to create a single, contiguous environment, the GUI presenting a portion of the single, contiguous environment, the whole environment and the portion of the environment determined by direct interaction of the devices utilizing the proximity and the relative positions of each of the devices;
iii. a software module for creating or identifying a data object in response to a first touchscreen gesture;
iv. a software module for transferring the data object in response to a second touchscreen gesture, the second gesture indicating at least one destination for the data object; and
v. a software module for stabilizing the configuration of the environment and data object transfer functionality when one or more of the mobile processing devices are removed from the environment or when the proximity or the relative position of at least one of the mobile processing devices is altered;
provided that the computer-implemented system is a distributed system.

2. The system of claim 1, wherein the plurality of mobile processing devices includes 2 to 20 devices.

3. The system of claim 1, wherein the GUI comprises a representation of a user.

4. The system of claim 1, wherein the environment is a representation of a boardroom, a conference room, or a classroom.

5. The system of claim 1, wherein the data object comprises: an image file, a video file, an audio file, a document, a text file, a word processor file, a spreadsheet, a presentation file, a calendar event, a task, an interactive element, an executable file, a combination thereof, or a database thereof.

6. The system of claim 1, wherein the application further comprises a software module for managing permissions for transferring data objects.

7. The system of claim 1, wherein the application further comprises a software module for creating a record of data objects transferred, the record comprising source, destination, and content.

8. Non-transitory computer readable storage media encoded with a mobile application including executable instructions that when provided to each of a plurality of touchscreen mobile devices create a distributed, interactive collaboration application comprising:
a. a software module for measuring proximity of each mobile device of the plurality of mobile devices provided the mobile application;
b. a software module for displaying a distributed, interactive collaboration GUI, wherein the GUI interacts with the other GUIs of the plurality of mobile processing devices to create a single, contiguous environment, the GUI presenting a portion of the single, contiguous environment, the whole environment and the portion of the environment determined by direct interaction of the devices utilizing the proximity and the relative positions of each of the devices;
c. a software module for creating or identifying a data object in response to a first touchscreen gesture;
d. a software module for transferring the data object in response to a second touchscreen gesture, the second gesture indicating at least one destination for the data object; and
e. a software module for stabilizing the configuration of the environment and data object transfer functionality when one or more of the mobile processing devices are removed from the environment or when the proximity or the relative position of at least one of the mobile processing devices is altered.

9. The media of claim 8, wherein the plurality of mobile devices includes 2 to 20 devices.

10. The media of claim 8, wherein the GUI comprises a representation of a user.

11. The media of claim 8, wherein the environment is a representation of a boardroom, a conference room, or a classroom.

12. The media of claim 8, wherein the data object comprises: an image file, a video file, an audio file, a document, a text file, a word processor file, a spreadsheet, a presentation file, a calendar event, a task, an interactive element, an executable file, a combination thereof, or a database thereof.

13. The media of claim 8, wherein the application further comprises a software module for managing permissions for transferring data objects.

14. The media of claim 8, wherein the application further comprises a software module for creating a record of data objects transferred, the record comprising source, destination, and content.

15. (canceled)

16. A computer-implemented system comprising:
a. a plurality of mobile processing devices, each device comprising an operating system configured to perform executable instructions, a touchscreen, and a memory; and
b. a mobile application, provided to each mobile processing device, the application comprising:
i. a software module for measuring proximity of each of the devices;
ii. a software module for creating a distributed, interactive collaboration GUI, wherein the GUI interacts with the other GUIs of the plurality of mobile processing devices to create a single, contiguous environment, the GUI presenting a representation of the environment, the environment including representations of a plurality of users, the representations of the users displayed in the environment by direct interaction of the devices utilizing proximity and relative positions of each of the devices;
iii. a software module for creating or identifying a data object in response to a first touchscreen gesture;
iv. a software module for transferring the data object in response to a second touchscreen gesture, the second gesture indicating at least one destination for the data object; and
v. a software module for stabilizing the configuration of the environment and data object transfer functionality when one or more of the mobile processing devices are removed from the environment or when the proximity or the relative position of at least one of the mobile processing devices is altered;
provided that the computer-implemented system is a distributed system.

17. The system of claim 16, wherein the plurality of mobile processing devices includes 2 to 20 devices.

18. The system of claim 16, wherein the environment is a representation of a boardroom, a conference room, or a classroom.

19. The system of claim 16, wherein the data object comprises: an image file, a video file, an audio file, a document, a text file, a word processor file, a spreadsheet, a presentation file, a calendar event, a task, an interactive element, an executable file, a combination thereof, or a database thereof.

20. The system of claim 16, wherein the application further comprises a software module for managing permissions for transferring data objects.

21. The system of claim 16, wherein the application further comprises a software module for transferring the representation of the environment displayed on a device to one or more other devices.

22. The system of claim 16, wherein the application further comprises a software module for creating a record of data objects transferred, the record comprising source, destination, and content.

23. Non-transitory computer readable storage media encoded with a mobile application including executable instructions that when provided to each of a plurality of touchscreen mobile devices create a distributed, interactive collaboration application comprising:
a. a software module for measuring proximity of each mobile device of the plurality of mobile devices provided the mobile application;
b. a software module for creating a distributed, interactive collaboration GUI, wherein the GUI interacts with the other GUIs of the plurality of mobile processing devices to create a single, contiguous environment, the GUI presenting a representation of the environment, the environment including representations of a plurality of users, the representations of the users displayed in the environment by direct interaction of the devices utilizing proximity and relative positions of each of the devices;
c. a software module for creating or identifying a data object in response to a first touchscreen gesture;
d. a software module for transferring the data object in response to a second touchscreen gesture, the second gesture indicating at least one destination for the data object; and
e. a software module for stabilizing the configuration of the environment and data object transfer functionality when one or more of the mobile processing devices are removed from the environment or when the proximity or the relative position of at least one of the mobile processing devices is altered.

24. The media of claim 23, wherein the plurality of mobile devices includes 2 to 20 devices.

25. The media of claim 23, wherein the environment is a representation of a boardroom, a conference room, or a classroom.

26. The media of claim 23, wherein the data object comprises: an image file, a video file, an audio file, a document, a text file, a word processor file, a spreadsheet, a presentation file, a calendar event, a task, an interactive element, an executable file, a combination thereof, or a database thereof.

27. The media of claim 23, wherein the application further comprises a software module for managing permissions for transferring data objects.

28. The media of claim 23, wherein the application further comprises a software module for transferring the representation of the environment displayed on a device to one or more other devices.

29. The media of claim 23, wherein the application further comprises a software module for creating a record of data objects transferred, the record comprising source, destination, and content.

30. (canceled)
